(19) United States
(12) Patent Application Publication
(10) Pub. No.: US 2011/0223310 A1
(43) Pub. Date: Sep. 15, 2011

(54) PURIFIED GREEN TEA EXTRACT

(75) Inventor: Tomoko Konishi, Sumida-ku (JP)

(73) Assignee: Kao Corporation, Tokyo (JP)

(21) Appl. No.: 13/130,453

(22) PCT Filed: Nov. 20, 2009
(86) PCT No.: PCT/JP2009/006262

§ 371 Date: May 20, 2011

(30) Foreign Application Priority Data
Nov. 21, 2008 (JP) 2008-298313

(51) Int. Cl. A23F 3/16

(52) U.S. Cl. 426/597; 426/655

(57) ABSTRACT

Provided is a purified green tea extract, which contains catechins at high concentration and is reduced in unpleasant astringent taste. The purified green tea extract according to the present invention contains (A) non-polymer catechins and (B) rutin. A content weight ratio [(B)/(A)] of the rutin (B) to the non-polymer catechins (A) is not greater than 0.03, and a ratio of gallate forms in the non-polymer catechins (A) is from 0.01 to 70 wt %.

### FIELD OF THE INVENTION

This invention relates to a purified green tea extract and a food or beverage containing the purified green tea extract.

### BACKGROUND OF THE INVENTION

Methods are known to add catechins to diets such as beverages by using tea extracts such as concentrated green tea extracts.

If, however, an attempt is made to ingest the non-polymer catechins at high concentration by dissolving the concentrated green tea extract in a liquid, the catechins give bitterness and astringency, and moreover, other components contained in the concentrated green tea extract increase bitterness, astringency, astringent taste, harshness and coarseness.

For the reduction of such unpleasant bitterness and astringency, it is effective to eliminate admixed components such as caffeine and polyphenols from a tea extract. As methods for the elimination, adsorption methods (Patent Documents 1 to 3), extraction methods (Patent Documents 4 to 5), and the like are known.

On the other hand, rutin contained in tea is known merely as a component that supports the quality of black tea like theaflavins (Non Patent Document 1)

### PRIOR ART DOCUMENTS

### Patent Documents

Patent Document 1 JP-A-05-153910
Patent Document 2 JP-A-08-109178
Patent Document 3 JP-A-2002-335911
Patent Document 4 JP-A-01-289447
Patent Document 5 JP-A-59-219384

### Non Patent Document

Non Patent Document 1 J. Agric. Food. Chem. 2005, 53, 5377-5384

### SUMMARY OF THE INVENTION

The present invention provides a purified green tea extract containing the following ingredients (A) and (B):

(A) non-polymer catechins, and

(B) rutin,

wherein a content weight ratio [(B)/(A)] of the rutin (B) to the non-polymer catechins (A) is not greater than 0.03, and a ratio of gallate forms in the non-polymer catechins (A) is from 0.01 to 70 wt %.

The present invention also provides a food or beverage containing the purified green tea extract.

### PREFERRED EMBODIMENTS OF THE INVENTION

To have the physiological effects of catechins effectively made to appear, it is indispensable to continuously ingest catechins over a long period of time. According to the above-described conventional methods, bitterness and astringency can be improved, but an unpleasant astringent taste can hardly be considered to have been reduced sufficiently. To provide a purified green tea extract which contains catechins at high concentration, is reduced in such unpleasant astringent taste and can be continuously ingested, there is hence a room for improvements.

Therefore, the present invention provides a purified green tea extract which contains catechins at high concentration and is reduced in unpleasant astringent taste, and also, a food or beverage containing the purified green tea extract.

The purified green tea extract according to the present invention is reduced in unpleasant astringent taste and is excellent in color despite the inclusion of the non-polymer catechins at high concentration. When added to foods and beverages the purified green tea extract according to the present invention, it enables the development of a wide variety of applications, and further, permits continued ingestion of the non-polymer catechins over a long period of time so that the physiological effects of the non-polymer catechins can be fully expected.

With a view to developing a food or beverage that contains the non-polymer catechins at high concentration and can be continuously ingested over a long period of time, the present inventor conducted research on the unpleasant astringent taste of a purified green tea extract to be added to such a food or beverage. As a result, it was found that the astringent taste of the purified green tea extract is attributable to rutin contained in the purified green tea extract. As a result of further research by the present inventor, it has also been found that rutin itself does not give an unpleasant astringent taste but, when it coexists with the high-concentration non-polymer catechins in a purified green tea extract, the unpleasant astringent taste is strongly felt. Further, it has also been found that a reduction in unpleasant astringent taste can be materialized by reducing the content weight ratio of rutin to the non-polymer catechins in a purified green tea extract to a specific range. In addition, it has also been found that an unexpected advantageous effect can be brought about in that such a purified green tea extract is also improved in color.

The term “(A) non-polymer catechins” as used herein is a generic term, which collectively encompasses non-epi-form catechins such as catechin, gallocatechin, catechin gallate and gallocatechin gallate, and epi-form catechins such as epicatechin, epigallocatechin, epicatechin gallate and epigallocatechin gallate. The concentration of the non-polymer catechins is defined based on the total amount of the above-described eight non-polymer catechins.

The term “gallate forms of the non-polymer catechins” as used herein is a generic term, which collectively encompasses catechin gallate, gallocatechin gallate, epicatechin gallate and epigallocatechin gallate. The term “ratio of gallate forms in the non-polymer catechins” indicates the percentage value of a total weight of the four non-polymer catechin gallates based on a total weight of the eight non-polymer catechins.

Rutin is a kind of flavonoid, and is a glycoside that a β-rutinose (6-O-α-L-rhamnosyl-D-β-glucose) is linked to the oxygen atom at 3-position in quercetin.

The purified green tea extract according to the present invention is characterized in that the content of rutin is pronouncedly reduced. Described specifically, the content of rutin (B) is not higher than 0.03 in terms of its weight ratio [(B)/(A)] to the non-polymer catechins (A). From the viewpoint of reducing the astringent taste, however, the content of rutin (B) may be preferably not higher than 0.025, more preferably not higher than 0.02, more preferably not higher than 0.015, even more preferably not higher than 0.010. It is to be noted that the lower limit of the weight ratio [(B)/(A)] may be preferably 0.0001 or greater, more preferably 0.005 or greater from the viewpoint of the efficiency of purification although it may be 0, in other words, substantially no rutin is contained. The expression “substantially no rutin is contained” as used herein means that the content of rutin is below a detection limit in the “measurement of rutin” to be described subsequently in examples.

In the purified green tea extract according to the present invention, the ratio of gallate forms in the non-polymer catechins is from 0.01 to 70 wt %, but from the viewpoint of reducing bitterness, may be preferably from 0.1 to 60 wt %, more preferably from 1 to 55 wt %, more preferably from 1 to 50 wt %, more preferably from 1 to 45 wt %, even more preferably from 1 to 40 wt %.

To permits easy and continuous ingestion of the non-polymer catechins in a large amount, the purified green tea extract according to the present invention may contain preferably from 25 to 95 wt %, more preferably from 36 to 95 wt %, more preferably from 40 to 90 wt %, eve more preferably from 50 to 80 wt % of the non-polymer catechins in its solids. The term “solids” as used herein means a dry residue obtained by drying a sample for 3 hours in an electric constant-temperature dryer controlled at 105° C.

For the purified green tea extract according to the present invention, the lower the content weight ratio [(C)/(A)] of (C) caffeine to (A) the non-polymer catechins, the better. Described specifically, the weight ratio [(C)/(A)] may be preferably not greater than 0.17, more preferably not greater than 0.15, even more preferably not greater than 0.13. Within this range, caffeine is not over-ingested upon ingestion of the non-polymer catechins. This range is also preferred from the standpoint of reducing bitterness and astringency. It is to be noted that the lower limit of the weight ratio [(C)/(A)] may be preferably 0.001 or greater, more preferably 0.01 or greater from the viewpoint of the efficiency of purification although it may be 0, in other words, substantially no caffeine is contained. The expression “substantially no caffeine is contained” as used herein means that the content of caffeine is below a detection limit in the “measurement of caffeine” to be described subsequently in the examples of this application.

Further, the purified green tea extract according to the present invention may have a color of preferably not higher than 0.8, more preferably not higher than 0.7, more preferably not higher than 0.6, even more preferably not higher than 0.5. This value can provide the purified green tea extract with a still better color. It is to be noted that the term “color” as used herein means a value of OD400 as measured by the method described in the examples to be set out subsequently herein.

As a green tea extract for use in purification, an extract solution obtained from green tea leaves can be mentioned as an example. As green tea leaves for use in extraction, green tea leaves manufactured from tea leaves available from the Genus Camellia, for example, C. sinensis, C. assamica, the Yabukita variety, or a hybrid thereof can be mentioned. Manufactured tea leaves include sencha, bancha, gyokuro, tencha, kamairicha and the like. It is also possible to use green tea leaves subjected to treatment in contact with carbon dioxide in its supercritical state.

As a method for extracting tea, a conventional method such as stirring extraction, column extraction or drip extraction can be adopted as an example. An organic acid or organic acid salt, such as sodium ascorbate, may be added beforehand to extraction water. It is also possible to make combined use of boiling deaeration or an extraction method which is conducted while bubbling an inert gas such as nitrogen gas to eliminate dissolved oxygen, that is, under the so-called non-oxidizing atmosphere. The extract solution obtained as described above can be used in the present invention as it is or after it is dried or concentrated. Examples of the form of such a green tea extract include a liquid, a slurry, semi-solids, solids and so on.

As the green tea extract, one obtained by dissolving or diluting a concentrated green tea extract solution in/with water or an organic solvent may be used instead of an extract solution extracted from green tea leaves. Further, an extract solution extracted from green tea leaves and a concentrated green tea extract solution may be used in combination. The term “concentrated green tea extract solution” as used herein means one obtained by removing at least a portion of water and/or a hydrophilic organic solvent from an extract solution extracted from tea leaves with such water and/or a solvent, and such a concentrated green tea extract solution can be prepared, for example, by a process disclosed in JP-A-59-219384, JP-A-04-020589, JP-A-05-260907, JP-A-05-306279 or the like. As a concentrated green tea extract, a commercially-available product may be used. For example, “POLYPHENON” (product of Mitsui Norin Co., Ltd.), “TEAFURAN” (product of ITO EN, LTD.), “SUNPHENON” (product of Taiyo Kagaku Co., Ltd.), or the like can be mentioned.

To obtain a purified green tea extract with the weight ratio [(B)/(A)] of which falls within the above-described range, it is necessary to decrease the absolute amount of rutin. As an illustrative method for achieving this decrease, the following method (i) or (ii) can be mentioned.

(i) With a hydrophobic organic solvent, a green tea extract is separated into two phases, the hydrophobic organic solvent is distilled off from the resulting organic layer, water is added to it to prepare an aqueous solution, and after that, the aqueous solution is treated at least once in contact with activated carbon.

(ii) A hydrophilic organic solvent and water are mixed in a green tea extract, the resulting precipitates are separated, the resulting solution is subjected to centrifugal separation at a temperature of 25° C. or lower (preferably from 5 to 20° C.), the resulting precipitates are separated, and then, the resulting solution is treated at least twice in contact with activated carbon in an aqueous solution of the hydrophilic organic solvent or in water.

As the green tea extract, one subjected to treatment with an enzyme having tannase activity may also be used. As a tannase treatment method, it is possible to adopt, for example, the method described in JP-A-2004-321105.

As the hydrophobic organic solvent for use in the purification of the green tea extract, no particular limitation is imposed insofar as it can separate the green tea extract into an organic layer and a water layer. For example, hydrocarbons such as hexane and toluene, halogenated hydrocarbons such as dichloromethane, and esters such as ethyl acetate can be exemplified. Among these, the esters are preferred, with ethyl acetate being more preferred, in view of the use of the purified green tea extract in foods and beverages. The hydrophobic organic solvent may be used preferably in an amount of from 1 to 50 times, more preferably in an amount of from 10 to 40 times the weight (dry weight) of the green tea extract from the standpoint of the efficiency of purification. As the green tea extract in this case, a green tea extract obtained by extracting green tea leaves with water or hot water or one obtained by diluting a concentrated green tea extract with water can be suitably used.

As the hydrophilic organic solvent, on the other hand, alcohols such as methanol and ethanol and ketones such as acetone can be exemplified. Among these, the alcohols are preferred, with ethanol being more preferred, from the standpoint of the use of the purified green tea extract in foods and beverages. The mixing weight ratio of the hydrophilic organic solvent to water may be preferably from 60/40 to 97/3, more preferably from 60/40 to 95/5, even more preferably from 85/15 to 95/5. From the standpoints of the efficiency of extraction of the non-polymer catechins, the efficiency of purification of the green tea extract, and so on, it is preferred to use the aqueous solution of the hydrophilic organic solvent at a weight ratio of from 2 to 8 times, with from 3 to 6 times being more preferred, relative to the weight (dry weight) of the green tea extract.

No particular limitation is imposed on the activated carbon for use in the contact treatment insofar as it is generally used on an industrial level. Usable examples include commercially-available products such as “ZN-50” (product of Hokuetsu Carbon Industry Co., Ltd.), “KURARAY COAL GLC”, “KURARAY COAL PK-D” and “KURARAY COAL PW-D” (products of Kuraray Chemical K.K.), and “SHIROWASHI AW50”, “SHIROWASHI A”, “SHIROWASHI M” and “SHIROWASHI C” (products of Takeda Pharmaceutical Company Limited).

The amount of the activated carbon to be used may be preferably from 0.01 to 8 parts by weight, more preferably from 0.02 to 5 parts by weight, even more preferably from 0.02 to 3 parts by weight, relative to 100 parts by weight of water or the aqueous solution of the hydrophilic organic solvent in that the efficiency of decaffeination is high and the cake resistance in the filtration step is low.

The treatment time may preferably include an aging time of from 10 to 180 or so minutes, and these treatments may be conducted at preferably from 10 to 60° C., more preferably from 10 to 50° C., even more preferably from 10 to 40° C.

The weight ratio [(C)/(A)] in the purified green tea extract can be controlled into the above-described range by conducting the contact treatment with an increased amount of the activated carbon or by conducting a plurality of the contact treatments. When a plurality of the contact treatments with activated carbon is conducted, it is preferred to include a filtration step between the respective treatment steps.

No particular limitation is imposed on a centrifuge insofar as it can be cooled. Ordinary equipment such as a separation-plate-type centrifuge, cylinder-type centrifuge or decanter-type centrifuge can be used. As conditions for centrifugal separation, the temperature may be 25° C. or lower, preferably from 5 to 20° C., more preferably from 10 to 15° C. The rotational speed and time may desirably be set under conditions adjusted to give a predetermined color. In the case of a separation-plate-type centrifuge, for example, the rotational speed may range preferably from 3,000 to 10,000 r/min, more preferably from 5,000 to 10,000 r/min, eve more preferably from 6,000 to 10,000 r/min, and the time may range preferably from 0.2 to 30 minutes, more preferably from 0.2 to 20 minutes, even more preferably from 0.2 to 15 minutes.

A membrane filter for use in each filtration step may be preferably from 0.01 to 10 μm, more preferably from 0.1 to 0.5 μm in pore size, and its material may preferably be nitrocellulose, polyvinyl chloride, polytetrafluoroethylene, or the like.

As the purified green tea extract according to the present invention obtained as described above is reduced in unpleasant astringent taste despite the inclusion of the non-polymer catechins at high concentration, the purified green tea extract enables the development of a wide variety of applications. For example, the purified green tea extract according to the present invention can be used by adding it to foods or beverages as it is. In such an application, the solvent may be eliminated by a method such as reduced-pressure concentration or thin-film concentration. When a powder is desired as the product form of the purified green tea extract, the purified green tea extract can be formed into a powder by a method such as spray drying or freeze drying. The water content of the purified green tea extract may be preferably not higher than 10 wt %, more preferably not higher than 8 wt %, even more preferably not higher than 5 wt %. On the other hand, the lower limit of its water content may be preferably 0.1 wt %, more preferably 1 wt %, even more preferably 3 wt %. This range makes it possible to avoid decay, coloration or the like of the purified green tea extract, to provide the non-polymer catechins with enhanced stability, and also to provide the non-polymer catechins with improved water solubility without production of turbidity upon preparing a beverage. It is to be noted that the water content of the purified green tea extract is a value as measured by a method described in the examples to be set out subsequently herein.

In the present invention, the purified green tea extract is excellent in color, and therefore, can be preferably used in beverages.

Beverages according to the present invention include, for example, tea beverages and non-tea beverages. Examples of the tea beverages include green tea beverages, oolong tea beverages, and black tea beverages. On the other hand, examples of the non-tea beverages include non-alcoholic drinks such as refreshing drinks (e.g., fruit juices, vegetable juices, sports drinks, isotonic drinks), coffee drinks, nutrition-supplement drinks, and beauty supplement drinks; and alcoholic drinks such as beer, wine, sake, plum liqueur, sparkling liquors, whisky, brandy, distilled spirits, rum, gin, and liqueurs.

Also, foods include confectioneries (e.g., breads, cakes, baked confections such as cookies and biscuits, chewing gums, chocolates, candies), desserts (e.g., jellys, yoghurts, ice creams), retort foods, and seasonings (e.g., sauces, soups, dressings, mayonnaises, creams). No particular limitation is imposed on the form of a food or beverage, and a food or beverage may be in any one of solid, powder, liquid, gel, slurry and like forms insofar as it is in a palatable form.

In the food or beverage making use of the purified green tea extract according to the present invention, the concentration of the non-polymer catechins may be adjusted to from 0.05 to 0.5 wt %, preferably from 0.06 to 0.5 wt %, more preferably from 0.08 to 0.5 wt %, more preferably from 0.092 to 0.4 wt %, more preferably from 0.11 to 0.3 wt %, even more preferably from 0.12 to 0.3 wt % in that the food or beverage can be provided with richness and a good taste and flavor without any unpleasant astringent taste.

To the beverage according to the present invention, additives such as antioxidants, flavorings, organic acids, organic acid salts, inorganic acids, inorganic acid salts, inorganic salts, colorants, emulsifiers, preservatives, seasonings, sweeteners, sour seasonings, gums, oils, vitamins, amino acids, fruit extracts, vegetable extracts, flower honey extracts, pH adjuster and quality stabilizers may be added either singly or in combination.

The pH (25° C.) of the beverage according to the present invention may be adjusted to preferably from 2 to 7, more preferably from 2 to 6.5 from the standpoints of the taste of the beverage and the stability of the non-polymer catechins.

The beverage according to the present invention can be provided as a packaged beverage filled in a package of a conventional form, such as a molded package made of polyethylene terephthalate as a principal component (a so-called PET bottle), a metal can, a paper package combined with metal foils or plastic films, a bottle or the like.

The packaged beverage can be produced, for example, by filling the beverage in a package such as a metal can, and after that when heat sterilization is feasible, conducting heat sterilization under sterilization conditions prescribed in the Food Sanitation Act. For those which cannot be subjected to retort sterilization like PET bottles or paper packages, a process is adopted such that the beverage is sterilized beforehand at a high temperature for a short time under similar sterilization conditions as those described above, for example, by a plate-type heat exchanger or the like, is cooled to a particular temperature, and is then filled in a package. Under aseptic conditions, additional ingredients may be mixed into and filled in a beverage-filled package.

### EXAMPLES

### (1) Measurements of Non-Polymer Catechins and Caffeine

A sample solution was filtered through a filter (0.45 μm). Using a high-performance liquid chromatograph (model: “SCL-10AVP”; manufactured by Shimadzu Corporation), a liquid chromatograph column packed with octadecyl group-introduced silica gel, “L-Column, TM ODS” (4.6 mm in diameter×250 mm; product of Chemicals Evaluation and Research Institute, Japan) was fitted. The filtered sample solution was then subjected to chromatography at a column temperature of 35° C. by the gradient elution method. A mobile phase, Solution A, was an aqueous solution containing acetic acid at 0.1 mol/L in distilled water, while another mobile phase, Solution B, was a solution containing acetic acid at 0.1 mol/L in acetonitrile. The measurement was conducted under the conditions of 1 mL/min flow rate, 10 μL sample injection volume and 280 nm UV detector wavelength. Gradient conditions were set as follows.

| | Concentration of | Concentration of |
|---|---|---|
| Time | solution A | solution B |
| (min) | (vol %) | (vol %) |
| 0 | 97% | 3% |
| 5 | 97% | 3% |
| 37 | 80% | 20% |
| 43 | 80% | 20% |
| 43.5 | 0% | 100% |
| 48.5 | 0% | 100% |
| 49 | 97% | 3% |
| 60 | 97% | 3% |

### (2) Measurement of Rutin

A sample solution was filtered through a filter (0.45 μm). Using a high-performance liquid chromatograph (model: “Waters2695”; manufactured by Waters Corporation), a column (Shimpack VP ODS”, 150×4.6 mm I.D.) was fitted. The filtered sample solution was then subjected to chromatography at a column temperature of 40° C. by the gradient elution method. A mobile phase, Solution C, was an aqueous solution containing phosphoric acid at 0.05 wt % in distilled water, while another mobile phase, Solution D, was a methanol solution. The measurement was conducted under the conditions of 1 mL/min flow rate, 10 μL sample injection volume and 368 nm UV detector wavelength. Gradient conditions were set as follows.

| | Concentration of | Concentration of |
|---|---|---|
| Time | solution C | solution D |
| (min) | (vol %) | (vol %) |
| 0 | 95% | 5% |
| 20 | 80% | 20% |
| 40 | 30% | 70% |
| 41 | 0% | 100% |
| 46 | 0% | 100% |
| 47 | 95% | 5% |
| 60 | 95% | 5% |

### (3) Evaluation of Bitterness by the Quinine Sulfate Method (the Equivalent Concentration Test Method))

Quinine sulfate dihydrate was adjusted to concentrations corresponding to the bitterness intensities shown in Table 1. After the purified green tea extract obtained in each of examples and comparative example was diluted with deionized water to a non-polymer catechins concentration of 0.2 wt %, a sensory test was performed by the panel of four evaluators. As the sensory test, each sample for the evaluation was tasted, and through a deliberation, a determination was made concerning to which sample of the standard bitterness solutions the intensity of bitterness was equal.

TABLE 1
Concentrations of Standard Bitterness Solutions

| | Quinine sulfate dihydrate |
|---|---|
| Bitterness intensity | (g/100 mL, aq.) |
| 1 | 0.00023 |
| 2 | 0.00050 |
| 3 | 0.00094 |
| 4 | 0.00157 |
| 5 | 0.00241 |
| 6 | 0.00388 |
| 7 | 0.00608 |
| 8 | 0.00985 |
| 9 | 0.01572 |
| 10 | 0.02568 |

### (4) Evaluation of Astringent Taste

After the purified green tea extract obtained in each of the examples and comparative examples was diluted with deionized water to the concentration of the non-polymer catechins to 0.2 wt %, a sensory test was performed by the panel of four evaluators. As the sensory test, an unpleasant astringent taste shortly after drinking was evaluated in accordance with the below-described standards, and a final score was then determined through deliberation.

Score 5: Strong astringent taste
4: Lightly strong astringent taste
3: Lightly weak astringent taste
2: Slightly weak astringent taste
1: Weak astringent taste

### (5) Measurement of Color (OD400)

Using a spectrophotometer (Model: U2810; manufactured by Hitachi, Ltd.), each sample adjusted to a non-polymer catechins concentration of 0.2 wt % was measured for absorbance at 400 nm.

### (6) Measurement of Water Content

The water content of each purified green tea extract was measured by the normal-pressure heating and drying method. Described specifically, each sample (approx. 1 g) was weighed and dried at 105° C. for 3 hours, and the sample after the drying was weighed. From the weights of the sample before and after the drying, the water content (wt %) per solids content was calculated.

### Production Example 1

### Green Tea Extract 1

Hot water of 88° C. (45 kg) was added to green tea leaves (produce of Kenya, Camellia sinensis. var. assamica; 3 kg), and batchwise extraction was conducted for 60 minutes under stirring. After coarse filtration was conducted through a 100-mesh metal screen, a centrifugal separation operation was performed to remove fine particle from the extract solution, whereby a “green tea extract solution” (36.8 kg, pH 5.3) was obtained (the concentration of the non-polymer catechins in the green tea extract solution=0.88 wt %, the ratio of gallate forms in the non-polymer catechins=51.6 wt %, caffeine=0.17 wt %). A portion of the green tea extract solution was freeze-dried to obtain a “green tea extract 1” as a concentrate of the green tea extract solution. The concentration of the non-polymer catechins in the “green tea extract 1”=32.8 wt %, the ratio of gallate forms in the non-polymer catechins=51.6 wt %, caffeine/non-polymer catechins ratio=0.193.

### Production Example 2

### Green Tea Extract 2

Hot water at 88° C. (45 kg) was added to green tea leaves (produce of Kenya, Camellia sinensis. var. assamica; 3 kg), and batchwise extraction was conducted for 60 minutes under stirring. After coarse filtration was conducted through a 100-mesh metal screen, a centrifugal separation operation was performed to remove fine powder from the extract solution, whereby a “green tea extract solution” (36.8 kg, pH 5.3) was obtained (the concentration of the non-polymer catechins in the green tea extract solution=0.88 wt %, the ratio of gallate forms in the non-polymer catechins=51.6 wt %, caffeine=0.17 wt %). The green tea extract solution was held at a temperature of 15° C., and tannase (“TANNASE KTFH”, product of Kikkoman Corporation; 500 U/g) was then added to the green tea extract solution to give a concentration of 430 ppm. The solution was held for 55 minutes, and was then heated to 90° C., at which the solution was held for 2 minutes to inactivate the enzyme so that the reaction was terminated (pH 5.2). Under conditions of 70° C. and 6.7 kPa, concentration processing was performed to a Brix concentration of 20% by reduced-pressure concentration. Further, the concentrate was spray-dried to obtain a “green tea extract 2” (1.0 kg) as a powdery concentrate of the extract solution. The thus-obtained “green tea extract 2” had the following data: the content of the non-polymer catechins=30.5 wt %, the ratio of gallate forms in the non-polymer catechins=31.6 wt %, caffeine/non-polymer catechins ratio=0.183.

### Example 1

After the “green tea extract 1” (5.0 g) was dissolved in deionized water (100 g), ethyl acetate (100 mL) was added, followed by mixing. After allowed to separate into layers by leaving it as it is, the water layer was removed, then, ethyl acetate was distilled off by an evaporator, and water was added. The resulting aqueous solution was brought into contact with activated carbon (0.025 g; “TAIKO SGP”, product of Futamura Chemical Co., Ltd.) and then subjected to filtration through a 0.2-μm membrane filter. Subsequently, it was freeze-dried under conditions of 93.3 Pa and 25° C. to obtain a “purified green tea extract 1”. Its analysis data are shown in Table 2.

### Example 2

A “purified green tea extract 2” was obtained in a similar manner as in Example 1, except that the “green tea extract 2” (5.0 g) was used in place of the “green tea extract 1” (5.0 g). Its analysis data are shown in Table 2.

### Example 3

The “green tea extract 1” (200 g) was charged into a 92 wt % aqueous solution of ethanol (800 g), and still at room temperature, stirring was continued for approx. 3 hours. Subsequently, the resulting precipitates were filtered off through No. 2 filter paper. Deionized water (417 g) was added to the thus-obtained filtrate, followed by stirring for approx. 5 minutes under stirring conditions of 15° C. and 100 rpm. The mixed solution was subjected to a small cooled centrifuge (manufactured by Hitachi Koki Co., Ltd.) to remove the precipitated turbidity components at an operation temperature of 15° C. (6,000 rpm, 5 minutes). The resulting solution was brought into contact with activated carbon (30 g; “KURARAY COAL GLC”, product of Kuraray Chemical Co., Ltd.), followed by filtration through a 0.2-μm membrane filter. The alcohol was next distilled off by an evaporator. The resulting solution was brought into contact with activated carbon (1 g; “TAIKOSGP”, product of Futamura Chemical Co., Ltd.) and then subjected to filtration through a 0.2-μm membrane filter. Subsequently, it was freeze-dried under the conditions of 93.3 Pa and 25° C. to obtain a “purified green tea extract 3”. Its analysis data are shown in Table 2.

### Example 4

A “purified green tea extract 4” was obtained in a similar manner as in Example 3, except that the “green tea extract 2” (200 g) was used in place of the “green tea extract 1” (200 g). Its analysis data are shown in Table 2.

### Comparative Example 1

The “green tea extract 1” (200 g) was charged into a 92 wt % aqueous solution of ethanol (800 g), and still at room temperature, stirring was continued for approx. 3 hours. Subsequently, the resulting precipitates were filtered off through No. 2 filter paper. Deionized water (417 g) was added to the thus-obtained filtrate, followed by stirring for approx. 5 minutes under the stirring conditions of 15° C. and 100 rpm. The mixed solution was subjected to the small cooled centrifuge (manufactured by Hitachi Koki Co., Ltd.) to remove the precipitated turbidity components at the operation temperature of 15° C. (6,000 rpm, 5 minutes). The alcohol was distilled off from the resulting solution by the evaporator, and then it was freeze-dried under the conditions of 93.3 Pa and 25° C. to obtain a “green tea extract a”. Its analysis data are shown in Table 2.

### Comparative Example 2

A “green tea extract b” was obtained in a similar manner as in Comparative Example 1, except that the “green tea extract 2” (200 g) was used in place of the “green tea extract 1” (200 g). Its analysis data are shown in Table 2.

### Comparative Example 3

“POLYPHENON HG” (product of Mitsui Norin Co., Ltd.) was provided. Its analysis data are shown in Table 2.

TABLE 2

| | | | | | | Comparative | | |
|---|---|---|---|---|---|---|---|---|
| | | Examples | | | | Examples | | |
| | | 1 | 2 | 3 | 4 | 1 | 2 | 3 |
| Rutin (B)/non-polymer | — | 0.013 | 0.014 | 0.012 | 0.006 | 0.034 | 0.034 | 0.031 |
| catechins (A) | | | | | | | | |
| Ratio of gallate-forms | wt % | 69.3 | 31.4 | 52.8 | 25.9 | 55.5 | 27.9 | 54.6 |
| in non-polymer | | | | | | | | |
| catechins | | | | | | | | |
| Caffeine | — | 0.095 | 0.104 | 0.122 | 0.113 | 0.178 | 0.174 | 0.189 |
| (C)/non-polymer | | | | | | | | |
| catechins (A) | | | | | | | | |
| Concentration of | wt % | 75.2 | 69.6 | 55.8 | 53.6 | 53.2 | 51.7 | 31.9 |
| non-polymer catechins | | | | | | | | |
| in solids content | | | | | | | | |
| Color | — | 0.475 | 0.427 | 0.253 | 0.154 | 1.097 | 0.924 | 1.721 |
| Sensory evaluation | Bitterness | 8.0 | 6.5 | 6.7 | 5.0 | 7.5 | 5.8 | 8.5 |
| | Astringent | 3 | 2 | 1 | 1 | 4 | 4 | 5 |
| | taste | | | | | | | |

From Table 2, it has been found that controlling the weight ratio of rutin (B)/non-polymer catechins (A) and the ratio of gallate-forms to specific ranges makes it possible to obtain a purified green tea extract, which is reduced in unpleasant astringent taste, is good in taste and flavor and is excellent in color despite the inclusion of the non-polymer catechins at high concentration. It has also been found that a purified green tea extract, which is further reduced in bitterness and astringent taste, can be obtained by reducing the rate of gallate-forms in the non-polymer catechins to 26 wt % or small, especially as in Example 4.

### <Measurements of Water Content and Turbidity>

The freeze-dried products of the purified green tea extracts of Examples 1 to 4 and frozen products obtained by freezing the purified green tea extracts, as they were, instead of freeze drying in Examples 2 and 3 were measured for water content and also for turbidity (NTU) under the below-described conditions. The measurement results are shown in Table 3.

It is to be noted that as the turbidity, the freeze-dried products and frozen products were each dissolved to Brix 12 with deionized water and the turbidity of the resulting aqueous solution was measured. For the measurement of the turbidity, a turbidimeter (“TURBIDIMETER/TN-100”, manufactured by Eutech Instruments Pte Ltd.) was used, and the water content was measured by the method described above. With respect to the frozen products, their measurements were conducted after thawing them under thawing conditions of 25° C. and 10 minutes.

TABLE 3

| | | | | | Frozen | |
|---|---|---|---|---|---|---|
| | Freeze-dried products | | | | products | |
| | Ex. 1 | Ex. 2 | Ex. 3 | Ex. 4 | Ex. 2 | Ex. 3 |
| Water content (wt %) | 4.2 | 4.6 | 4.5 | 4.7 | 91.9 | 84.6 |
| Turbidity (NTU) | 5.26 | 5.89 | 2.94 | 2.86 | 35.4 | 39.8 |

From Table 3, it has been found that the turbidity upon dissolution of a purified green tea extract is lowered when its water content is reduced. It has also been found from this result that a reduction to 10 wt % or lower in water content of the purified green tea extract is effective for an improvement in solubility.

From an observation of appearances during storage, it has also been found that a purified green tea extract can be prevented from spoilage even at 25° C. if its water content is 10 wt % or lower and that the purified green tea extract can also be prevented from coloration during storage due to air oxidation or the like if the lower limit of its water content is 0.1 wt % or higher.

### Example 5

The purified green tea extracts of Examples 1 to 4 were used. By adding to them each components in the proportions shown in Table 4, beverages having a non-polymer catechins concentration of 0.11 wt % were prepared. The thus-obtained beverages were then subjected to sterilization treatment and hot-pack filling in accordance with the Food Sanitation Act to obtain packaged beverages. The resulting packaged beverages were free of an unpleasant astringent taste, and were palatable beverages.

TABLE 4

| | | Beverage | Beverage | Beverage | Beverage |
|---|---|---|---|---|---|
| Kinds of purified green | | 1 | 2 | 3 | 4 |
| tea extracts | | Ex. 1 | Ex. 2 | Ex. 3 | Ex. 4 |
| Formulation | Purified | 0.15 | 0.16 | 0.20 | 0.21 |
| (wt %) | green tea | | | | |
| | extract | | | | |
| | Sugars | 1.50 | 1.50 | 1.50 | 1.50 |
| | Salts | 0.33 | 0.33 | 0.33 | 0.33 |
| | Sweetener | 0.01 | 0.01 | 0.01 | 0.01 |
| | Vitamin C | 0.05 | 0.05 | 0.05 | 0.05 |
| | Fruit | 0.10 | 0.10 | 0.10 | 0.10 |
| | extract | | | | |
| | Flavoring | 0.20 | 0.20 | 0.20 | 0.20 |
| | Deionized | Balance | Balance | Balance | Balance |
| | water | | | | |

| | | | | |
|---|---|---|---|---|
| Total | 100.00 | 100.00 | 100.00 | 100.00 |

1. A purified green tea extract comprising the following ingredients (A) and (B):
(A) non-polymer catechins, and
(B) rutin,
wherein a content weight ratio [(B)/(A)] of the rutin (B) to the non-polymer catechins (A) is not greater than 0.03, and
a ratio of gallate forms in the non-polymer catechins (A) is from 0.01 to 70 wt %.

2. The purified green tea extract according to claim 1, wherein a content weight ratio [(C)/(A)] of caffeine (C) to the non-polymer catechins (A) is not greater than 0.17.

3. The purified green tea extract according to claim 1 or 2, which has a color not higher than 0.8.

4. The purified green tea extract according to any one of claims 1-3, which has a water content not higher than 10 wt % in the purified green tea extract.

5. A food comprising the purified green tea extract according to any one of claims 1-4.

6. A beverage comprising the purified green tea extract according to any one of claims 1-4.

7. The beverage according to claim 6, which is a packaged beverage.
